(19) United States
(12) Patent Application Publication
(10) Pub. No.: US 2025/0365811 A1
(43) Pub. Date: Nov. 27, 2025

(54) DEVICES, METHODS AND SYSTEM FOR CELL DTX/DRX

(71) Applicant: HUAWEI TECHNOLOGIES CO., LTD., Shenzhen (CN)

(72) Inventors: Minghan Jiao, Shenzhen (CN); Lei Guan, Beijing (CN); Ruijie Li, Beijing (CN); Louis Madier, Boulogne Billancourt (FR)

(73) Assignee: HUAWEI TECHNOLOGIES CO., LTD., Shenzhen (CN)

(21) Appl. No.: 19/296,808

(22) Filed: Aug. 11, 2025

Related U.S. Application Data
(63) Continuation of application No. PCT/CN2023/084934, filed on Mar. 30, 2023.

(51) Int. Cl. H04W 76/28; H04W 72/232

(52) U.S. Cl. CPC H04W 76/28; H04W 72/232

(57) ABSTRACT

The present disclosure relates to cell DTX/DRX in mobile communications systems. A network device configured with cell DTX/DRX is configured to send control information to a user device. The control information indicates a time window and is used to notify the user device that the configured cell DTX/DRX is to be skipped during the time window. Then, the network device and the user device are configured to skip the configured cell DTX/DRX during the time window temporarily without deactivating or modifying the configured cell DTX/DRX. Before and after the time window, the configured cell DTX/DRX still applies to the network device and the user device. In this way, urgent data can be transmitted temporarily during the time window, and the configured DTX/DRX is not substantially affected. In this way, more flexibility can be introduced and traffic QOS can be assured.

### CROSS-REFERENCE TO RELATED APPLICATIONS

This application is a continuation of International Application No. PCT/CN2023/084934, filed on Mar. 30, 2023, the disclosure of which is hereby incorporated by reference in its entirety.

### TECHNICAL FIELD

Embodiments of the present disclosure generally relate to the field of communications technology. For instance, the present disclosure provides devices, methods, and a system for cell discontinuous transmission and/or reception (cell DTX/DRX) in wireless communications networks.

### BACKGROUND

DTX and DRX are techniques commonly adopted by mobile devices (e.g. user equipment (UE)) to conserve power and increase battery life. Recently, cell DTX/DRX has been proposed to be applied to network devices (e.g., a base station), in order to save energy of the network devices. Similar to DTX/DRX configured at the mobile devices, cell DTX/DRX allows a network device to turn inactive for a predetermined period of time (called “non-active time/period/duration”) and become active for another predetermined period of time (called “active time/period/duration”). In this way, energy consumption of the network device can be reduced.

### SUMMARY

Network traffic is unpredictable. When an urgent type of traffic (e.g., ultra-reliable low latency communications (URLLC) or extended reality (XR) data) needs to be fulfilled, configured cell DTX/DRX may cause latency in delivering (i.e., transmitting/receiving) the traffic. Therefore, the QoS performance and throughput may be degraded due to the configured cell DTX/DRX.

A conventional solution is to deactivate or modify the configured cell DTX/DRX to ensure QoS of certain traffic (e.g., URLLC). However, when the traffic comes in bursts and randomly, it is quite often that the deactivated or modified cell DTX/DRX needs to be activated or restored after the traffic is delivered. This may reduce signaling efficiency, impact energy-saving performance brought by the cell DTX/DRX, and increase signaling overhead.

In view of the above-mentioned problems and disadvantages, the present disclosure aims to improve the mechanism of cell DTX/DRX. For instance, an objective may be to introduce flexibility in cell DTX/DRX. A further objective may be to solve the conflict between cell DTX/DRX and urgent network traffic.

These and other objectives are achieved by this disclosure, for instance, as described in the independent claims. Advantageous implementations are further described in the dependent claims.

A first aspect of the present disclosure provides a method performed by a network device. The network device is associated with one or more cells. At least one cell associated with the network device is configured with cell DTX and/or DRX. The method comprises the following steps:
sending, by the network device, control information to a user device, in which the control information indicates a time window, and the control information is used to notify the user device that the configured cell DTX and/or DRX is to be skipped during the time window; and
skipping, by the network device, the configured cell DTX and/or DRX during the time window for the user device.

Optionally, the time window may correspond to a number of consecutive symbols in time domain. The unit of the time window may be any suitable time unit in telecommunications, such as but not limited to: millisecond (ms), symbol length, time slot, subframe, transmission time interval (TTI), and the like. Optionally, the time window may be indicated as an absolute time period, or a relative time period with respect to a defined starting point.

It is noted that the configured cell DTX and/or DRX is skipped by the network device during the time window without deactivating or modifying the configured cell DTX and/or DRX after or before the time window. In another word, the control information is used to indicate that the configured cell DTX and/or DTX is temporarily paused for the user device during the time window. During the time window, the network device is configured to transmit and/or receive data regardless of the configured cell DTX and/or DRX.

Optionally, the network device may be a base station, the user device may be a mobile terminal. When the network device is configured to skip the configured cell DTX and/or DRX during the time window for the user device, the user device is also configured to skip the configured cell DTX and/or DTX during the time window.

Optionally, the control information may be sent by the network device to a specific single user device (i.e., the user device of the first aspect), or to a group of user devices including the user device, or to all user devices of the cell. Hence, the configured cell DTX and/or DRX may be skipped temporarily during the time window for a single user device, or for a group of user devices, or for all user devices in the cell, without modifying or deactivating the configured cell DTX and/or DRX before or after the time window.

It is noted that for any other further user device that does not obtain such control information from the network device, the configured cell DTX and/or DRX shall still apply. That is, the configured cell DTX and/or DRX does not change before, during, or after the time window between the network device and the further user device not obtaining the control information.

By using the control information to skip the configured cell DTX and/or DRX during the time window for the user device, the network device does not need to deactivate or modify the configured cell DTX and/or DRX in order to handle urgent user device downlink and/or uplink traffic. Signaling efficiency can be increased. Moreover, the impact on the configured cell DTX and/or DTX in order to handle urgent user device downlink and/or uplink traffic can be kept in a small scale, because the configured cell DTX/DRX is to be skipped (only) between the network device and the user device (or any user device obtaining the control information). The network device does not need to wake up any other further user devices not related to the urgent traffic. Therefore, more flexibility can be introduced into the cell DTX and/or DRX mechanism.

In an implementation form of the first aspect, the configured cell DTX and/or DRX relate to a plurality of cycles. Each cycle comprises active time (or an active period) and inactive time (or a non-active period). During the active period, the cell is active; while during the non-active period, the cell is not active for transmitting and/or receiving one or more certain signals and/or channels.

When the control information is sent during an active period, the time window may start from the first time slot of a non-active period subsequent to the active period, optionally with delay.

When the control information is sent on a specific time slot during a non-active period, the time window may start from the specific time slot, optionally with delay.

In a further implementation form of the first aspect, for indicating the time window, the control information may comprise a duration value denoting a length of the skipping window. Optionally, the unit of the duration value may be ms, symbol length, time slot, TTI, or subframe.

In a further implementation form of the first aspect, for indicating the time window, the control information may further comprise a shift (or offset) value denoting an amount of delay for starting the skipping window after receiving the control information. The unit of the shift value may be the same as the length of the duration value.

It is noted that the shift value is not necessary. For instance, a pre-defined delay may be used by the network device and the user device. Alternatively, the configured cell DTX and/or DRX shall be skipped immediately after sending the control information.

In a further implementation form of the first aspect, for indicating the time window, the control information may comprise an identity (ID) of a pre-defined time window. The pre-defined time window is defined by a duration value and an optional shift value.

Optionally, various time windows may be pre-defined and are known to the network device and the user device. For instance, the various time windows may be defined in a technical specification that the network device and the user device shall both comply. In this case, the control information may simply comprise an ID or index of a specific time window. In this way, signaling overhead can be further reduced.

In a further implementation form of the first aspect, the control information may further indicate that the time window applies to the configured cell DTX only, to the configured cell DRX only, or to both of the configured cell DTX and DRX.

When both cell DTX and DRX are configured, and only one of them needs to be skipped, the control information may comprise a first indication to indicate which configuration(s) to be skipped.

In this way, by further separating whether the configured cell DTX or DRX to be skipped, more flexibility can be introduced.

It is noted that this indication is not necessary. By default (e.g., without the first indication), the control information may be used to indicate both of the configured cell DTX and DRX (if both are configured) shall be skipped during the time window for the user device.

In a further implementation form of the first aspect, the cell may be one of a plurality of serving cells for carrier aggregation. The control information may further indicate that the time window applies to one or more other serving cells. To this end, the control information may comprise a second indication field.

Optionally, the cell may be a primary cell, and the one or more other serving cells may be one or more secondary cells.

In a further implementation form of the first aspect, the control information may further comprise a third indication field used to indicate whether the time window is applied to the user device only, or to a group of user devices, or to all user devices in the cell.

In this way, the network device may skip the configured cell DTX and/or DRX selectively for one or more specific user devices. More flexibility can be introduced.

In a further implementation form of the first aspect, the control information may be sent by the network device through downlink control information (DCI) associated with a specific type of radio network temporary identifier (RNTI). The specific type of RNTI may be newly defined in order to specifically indicate that the DCI relates to cell DTX and/or DRX skipping.

Alternatively, the control information may be sent by the network device through an information element (IE) of DCI. Optionally, the IE may be newly defined, or reuse an existing IE setting all bits to “1” or “0”.

A second aspect of the present disclosure provides a method performed by a user device. The user device is associated with one or more cells. At least one cell associated with the user device is configured with cell DTX and/or DRX. The method comprises:
receiving, by the user device, control information from a network device, in which the control information indicates a time window; and
skipping, by the user device, the configured cell DTX and/or DRX during the time window for the user device.

Optionally, the time window may correspond to a number of consecutive symbols in time domain. The unit of the time window may be any suitable time unit in telecommunications, such as but not limited to: ms, symbol length, time slot, subframe, TTI, and the like. Optionally, the time window may be indicated as an absolute time period, or a relative time period with respect to a defined starting point.

It is noted that the configured cell DTX and/or DRX is skipped by the user device during the time window without deactivating or modifying the configured cell DTX and/or DRX after or before the time window. In another word, the control information is used to indicate that the configured cell DTX and/or DTX is temporarily paused during the time window for the user device. During the time window, the user device is configured to receive and/or transmit data regardless of the configured cell DTX and/or DRX.

By using the control information to skip the configured cell DTX and/or DRX during the time window, the user device does not need to deactivate or modify the configured cell DTX and/or DRX in order to handle urgent uplink and/or downlink traffic. Signaling efficiency can be increased. Flexibility can be introduced into the cell DTX and/or DRX mechanism.

In an implementation form of the second aspect, before receiving the control information from the network device, the method further comprises sending, by the user device to the network device, a request to skip the configured cell DTX and/or DRX.

Optionally, the request may indicate the length of the time window and/or a latency requirement. The network device may acknowledge the request or propose its own time window if the request cannot be fulfilled, which may be transmitted to the user device using the control information.

Optionally, the request may be sent by the user device through uplink control information (UCI) or a medium access control (MAC) control element (CE).

In a further implementation form of the second aspect, the configured cell DTX and/or DRX relate to a plurality of cycles. Each cycle comprises active time (or an active period) and inactive time (or a non-active period). During the active period, the cell (and the user device) is active; while during the non-active period, the cell (and the user device) is not active for transmitting and/or receiving one or more certain signals and/or channels.

When the control information is received during an active period, the time window may start from the first time slot of a non-active period subsequent to the active period, optionally with delay.

When the control information is received on a specific time slot during a non-active period, the time window may start from the specific time slot, optionally with delay.

In a further implementation form of the second aspect, for indicating the time window, the control information may comprise a duration value denoting a length of the skipping window. Optionally, the unit of the duration value may be ms, symbol length, time slot, TTI, or subframe.

In a further implementation form of the second aspect, for indicating the time window, the control information may further comprise a shift (or offset) value denoting an amount of delay for starting the skipping window after receiving the control information. The unit of the shift value may be the same as the length of the duration value.

It is noted that the shift value is not necessary. For instance, a pre-defined delay may be used by the network device and the user device. Alternatively, the configured cell DTX and/or DRX shall be skipped immediately after receiving the control information.

In a further implementation form of the second aspect, for indicating the time window, the control information may comprise an identity (ID) of a pre-defined time window. The pre-defined time window is defined by a duration value and an optional shift value.

In this way, signaling overhead can be further reduced.

In a further implementation form of the second aspect, the control information may further indicate that the time window applies to the configured cell DTX only, to the configured cell DRX only, or to both of the configured cell DTX and DRX.

In this way, by further separating whether the configured cell DTX or DRX to be skipped, more flexibility can be introduced.

In a further implementation form of the second aspect, the control information may be received by the user device via DCI associated with a specific type of RNTI. The specific type of RNTI may be newly defined in order to specifically indicate that the DCI relates to cell DTX and/or DRX skipping.

Alternatively, the control information may be received by the user device via an IE of DCI.

A third aspect of the present disclosure provides a method performed by a user device. The user device is associated with one or more cells. At least one cell associated with the user device is configured with cell DTX and/or DRX. The method comprises the following steps:
sending, by the user device to a network device, a request to skip the configured DTX and/or DRX;
skipping, by the user device, the configured DTX and/or DRX during a time window with or without a confirmation of the request from the network device.

In this way, the user device can autonomously handle randomly arriving urgent traffic in case of configured cell DTX and/or DRX.

In this disclosure, for the case that the user device skips the configured DTX and/or DRX without a confirmation of the request from the network device, the following applies. The user device may assume by default that the network device also skips the configured DTX and/or DRX during the time window. The user device may assume that its request is correctly received by the network device, and that the network accepted the request. Normally, the network device detects a miss of a request of a user device with only a very low probability, for example, in the order of 10⁻⁴ to 10⁻⁵. Such a low request miss detection probability can achieved, because the request is carried in uplink control information (UCI) or in a medium access control (MAC) control element (MAC CE), and these types of control information are normally sent over well protected channels against decoding errors. Moreover, even if the network device would detect a miss of the request of the user device (despite the very low probability) or would refuse the request (also with a very low probability, since the network device may have configured the user device to send the skipping request without waiting for confirmation), the impact of omitting the confirmation of the request is still very limited to the power consumption of the user device.

In an implementation form of the third aspect, the request may comprise a one-bit flag. Alternatively, the request may indicate a desired time window to be skipped with an optional shift value.

Optionally, the request may be sent by the user device through UCI or MAC CE.

A fourth aspect of the present disclosure provides a network device. The network device is associated with one or more cells. At least one cell is configured with cell DTX and/or DRX. The network device is configured to:
send control information to a user device, in which the control information indicates a time window, and the control information is used to notify the user device that the configured cell DTX and/or DRX is to be skipped during the time window; and
skip the configured cell DTX and/or DRX during the time window for the user device.

In an implementation form of the fourth aspect, the configured cell DTX and/or DRX relate to a plurality of cycles. Each cycle comprises active time (or an active period) and inactive time (or a non-active period). During the active period, the cell is active; while during the non-active period, the cell is not active for transmitting and/or receiving one or more certain signals and/or channels.

When the control information is sent during an active period, the time window may start from the first time slot of a non-active period subsequent to the active period, optionally with delay.

When the control information is sent on a specific time slot during a non-active period, the time window may start from the specific time slot, optionally with delay.

In a further implementation form of the fourth aspect, for indicating the time window, the control information may comprise a duration value denoting a length of the skipping window. Optionally, the unit of the duration value may be ms, symbol length, time slot, TTI, or subframe.

In a further implementation form of the fourth aspect, for indicating the time window, the control information may further comprise a shift (or offset) value denoting an amount of delay for starting the skipping window after receiving the control information. The unit of the shift value may be the same as the length of the duration value.

In a further implementation form of the fourth aspect, for indicating the time window, the control information may comprise an ID of a pre-defined time window. The pre-defined time window is defined by a duration value and an optional shift value.

In a further implementation form of the fourth aspect, the control information may further indicate (e.g., through a first indication field) that the time window applies to the configured cell DTX only, to the configured cell DRX only, or to both of the configured cell DTX and DRX.

In a further implementation form of the fourth aspect, the cell may be one of a plurality of serving cells for carrier aggregation. The control information may further indicate that the time window applies to one or more other serving cells. To this end, the control information may comprise a second indication field.

In a further implementation form of the fourth aspect, the control information may further comprise a third indication field used to indicate whether the time window is applied to the user device only, a group of user devices, or all user devices in the cell.

In a further implementation form of the fourth aspect, the control information may be sent by the network device through DCI associated with a specific type of RNTI. The specific type of RNTI may be newly defined in order to specifically indicate that the DCI relates to cell DTX and/or DRX skipping.

Alternatively, the control information may be sent by the network device through an IE of DCI.

The network device of the fourth aspect may share the same optional features and the same technical effect as the method of the first aspect.

A fifth aspect of the present disclosure provides a user device. The user device is associated with one or more cells. At least one cell is configured with cell DTX and/or DRX. The user device is configured to:
receive control information from a network device, in which the control information indicates a time window; and
skip the configured cell DTX and/or DRX during the time window for the user device.

In an implementation form of the fifth aspect, before receiving the control information from the network device, the user device may be further configured to send a request for skipping the configured cell DTX and/or DRX to the network device. The request may be sent through UCI or a MAC CE.

In a further implementation form of the fifth aspect, the configured cell DTX and/or DRX relate to a plurality of cycles. Each cycle comprises active time (or an active period) and inactive time (or a non-active period). During the active period, the cell (and the user device) is active; while during the non-active period, the cell (and the user device) is not active for transmitting and/or receiving one or more certain signals and/or channels.

When the control information is received during an active period, the time window may start from the first time slot of a non-active period subsequent to the active period, optionally with delay.

When the control information is received on a specific time slot during a non-active period, the time window may start from the specific time slot, optionally with delay.

In a further implementation form of the fifth aspect, for indicating the time window, the control information may comprise a duration value denoting a length of the skipping window. Optionally, the unit of the duration value may be ms, symbol length, time slot, TTI, or subframe.

In a further implementation form of the fifth aspect, for indicating the time window, the control information may further comprise a shift (or offset) value denoting an amount of delay for starting the skipping window after receiving the control information. The unit of the shift value may be the same as the length of the duration value.

In a further implementation form of the fifth aspect, for indicating the time window, the control information may comprise an ID of a pre-defined time window. The pre-defined time window is defined by a duration value and an optional shift value.

In a further implementation form of the fifth aspect, the control information may further indicate that the time window applies to the configured cell DTX only, to the configured cell DRX only, or to both of the configured cell DTX and DRX.

In a further implementation form of the fifth aspect, the control information may be received by the user device via DCI associated with a specific type of RNTI. The specific type of RNTI may be newly defined in order to specifically indicate that the DCI relates to cell DTX and/or DRX skipping.

Alternatively, the control information may be received by the user device via an IE of DCI.

The user device of the fifth aspect may share the same optional features and the same technical effect as the method of the second aspect.

A sixth aspect of the present disclosure provides a user device. The user device is associated with one or more cells. At least one cell is configured with cell DTX and/or DRX. The user device is configured to:
send a request to skip the configured DTX and/or DRX to a network device;
skip the configured DTX and/or DRX during a time window with or without a confirmation of the request from the network device.

In an implementation form of the sixth aspect, the request may comprise a one-bit flag. Alternatively, the request may indicate a desired time window to be skipped with an optional shift value.

Optionally, the request may be sent by the user device through UCI or MAC CE.

The user device of the sixth aspect may share the same optional features and the same technical effect as the method of the third aspect.

A seventh aspect of the present disclosure provides a system comprising a network device according to the fourth aspect or any implementation form thereof, and one or more user devices according to the fifth or sixth aspect, or any implementation form thereof.

An eighth aspect of the present disclosure provides a computer program comprising a program code for performing the method according to the fourth aspect or any of its implementation forms.

A ninth aspect of the present disclosure provides a computer program comprising a program code for performing the method according to the fifth aspect or the sixth aspect, or any of its implementation forms.

A tenth aspect of the present disclosure provides a non-transitory storage medium storing executable program code which, when executed by a processor (or a chipset), causes the method according to the fourth aspect or any of its implementation forms to be performed.

An eleventh aspect of the present disclosure provides a non-transitory storage medium storing executable program code which, when executed by a processor (or a chipset), causes the method according to the fifth aspect or the sixth aspect, or any of its implementation forms to be performed.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of the present disclosure, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms will be explained in the following description in relation to the enclosed drawings, in which

FIG. 1 an example of a network device and a user device according to the present disclosure;

FIG. 2 a further example of a network device and a user device according to the present disclosure;

FIG. 3 an example of cell DTX/DRX skipping according to the present disclosure;

FIGS. 4A-4B shows further examples of cell DTX/DRX skipping according to the present disclosure;

FIG. 5 shows a diagram of a method according to the present disclosure;

FIG. 6 shows a diagram of a further method according to the present disclosure; and

FIG. 7 shows a diagram of a further method according to the present disclosure.

### DETAILED DESCRIPTION OF EMBODIMENTS

A list of key terms and their acronyms/abbreviations used in the present disclosure is given as follows: 3rd Generation Partnership Project—3GPP; Beam Failure Recovery—BFR; Control Element—CE; Configured Grant—CG; Downlink Control Information—DCI; Discontinuous Reception—DRX; Discontinuous Transmission—DTX; gNodeB—gNB; Hybrid Automatic Repeat Request—HARQ; Information Element—IE; Medium Access Control—MAC; Modulation Coding Scheme—MCS; New Radio—NR; Physical Downlink Control Channel—PDCCH; Physical Downlink Shared Channel—PDSCH; Paging Early Indication—PEI; power saving—PS; Physical Random Access Channel—PRACH; Quality of Service—QoS; Radio Network Temporary Identifier—RNTI; Cell RNTI—C-RNTI; Paging RNTI—P-RNTI; Random Access—RA; Radio Resource Control—RRC; System Information Block—SIB; Semi-Persistent Scheduling—SPS; Scheduling Request—SR; Synchronization Signal Block—SSB; Uplink Control Information—UCI; Ultra—Reliable Low Latency Communications—URLLC; User Equipment—UE; extended Reality—XR.

The present disclosure provides solutions for handling urgent traffic when cell DTX and/or DRX is configured. It is noted that cell DTX and/or DRX may be simply denoted as “cell DTX/DRX”, which may be referred to as either one of cell DTX and cell DRX is configured, or a combination of both is configured. Cell DTX/DRX in the present disclosure is different from DTX/DRX configured at UE (UE DTX/DRX). Cell DTX may be understood as “discontinuous transmission by base station”. Cell DRX may be understood as “discontinuous reception by base station”. UE DTX may be understood as “discontinuous transmission by UE”. UE DRX may be understood as “discontinuous reception by UE”. Since a base station is in principle in charge of the management of data transmissions in one or more cells, the mechanism of cell DTX/DRX is substantially different from UE DTX/DRX.

Cell DTX/DRX relates to a plurality of periodic cycles. Each cycle comprises an active period during which the cell is active, and a non-active period during which the cell is not active for transmitting and/or receiving one or more signals/channels. During the non-active period, the gNB may be in a sleep mode and shutdown unnecessary components in order to save energy.

Nevertheless, to ensure proper cell functioning, during the non-active period, the following options may be possible:
Example 1: gNB is expected to turn off all transmission and reception for data traffic and reference signal during cell DTX/DRX non-active periods (control traffic is not affected);
Example 2: gNB is expected to turn off its transmission/reception only for data traffic during cell DTX/DRX non-active periods (e.g., gNB will still transmit/receive reference signals)
Example 3: gNB is expected to turn off its dynamic data transmission/reception during cell DTX/DRX non-active periods (e.g., gNB is expected to still perform transmission/reception in periodic resources, including SPS, CG-PUSCH, SR, RACH, and SRS).
Example 4: gNB is expected to only transmit reference signals (e.g., CSI-RS for measurement).

Optionally, cell DTX may be applied to one or more of the following channels/signals: MCS-C-RNTI/PS-RNTI/RA-RNTI/SI-RNTI/P-RNTI/PEI-RNTI scrambled PDCCH; SSB; SIB; Paging; Message 2 (Msg2); Msg4; MsgB; BFR; and SPS PDSCH. Cell DRX may be applied to one or more of the following channels/signals: CG PUSCH; HARQ-(N) ACK of SPS PDSCH; SR; PRACH; MsgA; and Msg3.

In general, the present disclosure provides a first device sending control information to a second device. The first and the second device are in a cell configured with cell DTX/DRX. The control information is used to indicate that the configured cell DTX/DRX is to be skipped between the two devices during a time window. The time window may be pre-defined, or may be indicated by the control information. Then, the first and the second device are configured to skip the configured cell DTX/DRX between them during the time window temporarily without modifying or deactivating the configured cell DTX/DRX before or after the time window.

The cell DTX/DRX skipping may be initiated by a user device (UE initiated) or a network device (network initiated). In UE-initiated cell DTX/DRX skipping, the first device may be a user device (e.g., a mobile terminal, UE) and the second device may be a network device (e.g., a base station, gNB). The control information may be sent by the user device to the network device through UCI, or may be embedded in a MAC CE (e.g., BSR) as a request for skipping the cell DTX/DRX. In network-initiated cell DTX/DRX skipping, the first device may be the network device, and the second device may be the user device. The control information may be sent by the network device to the user device through DCI.

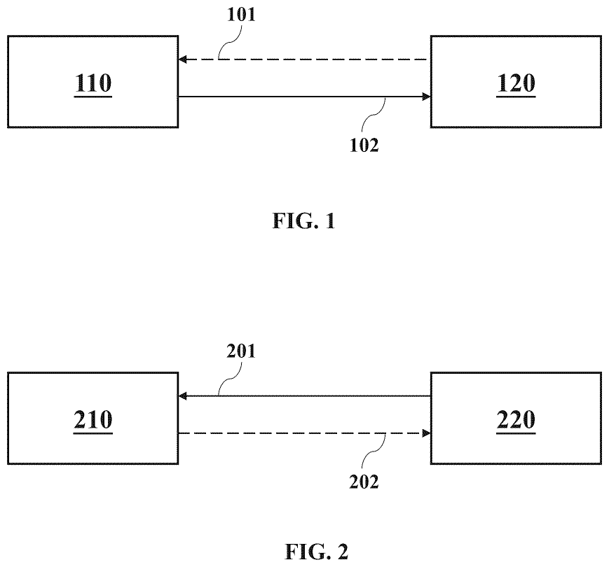

FIG. 1 shows an example of a network device 110 and a user device 120 according to the present disclosure. The network device 110 and the user device 120 are associated with a cell configured with cell DTX/DRX. In another word, the network device 110 is configured with cell DTX/DRX. Therefore, the cell that is managed by the network device 110 is also configured with cell DTX/DRX.

The network device 110 is configured to send control information 102 to the user device 120, e.g., when there is urgent downlink/uplink transmission or retransmission (e.g., URLLC, XR, etc.) coming. The control information 102 indicates a time window, and the control information 102 is used to notify (or indicate) the user device 120 that the configured cell DTX/DRX is to be skipped during the time window.

Optionally, for indicating the time window, the control information 102 may comprise a duration value indicating a length of the time window and an optional shift value indicating a delay in starting the time window.

Alternatively, the control information 102 may comprise an ID (or index) of a pre-defined time window configuration, which comprise a pre-defined duration value and a pre-defined optional shift value. Optionally, a plurality of pre-defined time window configurations may be defined as a table in a technical specification, which is followed by the network device and the user device. Alternatively, the plurality of pre-defined time window configurations may be provided by the network device to the user device, e.g., through RRC signaling.

Optionally, the control information 102 may be sent through a new type of DCI associated with a new type of RNTI. The DCI is carried on PDCCH. In a mobile communications network, a specific type of RNTI may be indicated by a specific value (simply refer to as an RNTI value), such as a hexa-decimal value in an exemplary range of “0000” to “FFFF”. The RNTI value may be used to scramble the control information 102 (e.g., the CRC part of a corresponding PDCCH carrying the DCI). The user device 120 can decode the RNTI value to determine the type of the DCI. In the present disclosure, a new type of RNTI may be defined and used for specifying the control information 102. It is noted that the control information 102 may not be impacted by cell DRX/DTX such that the control information 102 can be transmitted even in non-active periods of cell DTX. The user device 120 can be configured to monitor such kind of control information 102 (or such type of DCI), e.g., by RRC configuration. Optionally, a first type of RNTI may be used to indicate that the configured cell DTX is to be skipped, a second type of RNTI may be used to indicate that the configured cell DRX is to be skipped, and a third type of RNTI may be used to indicate that both of the configured cell DTX and DRX are to be skipped.

In alternative to defining a new type of DCI, the control information 102 may be sent through an existing type of DCI with a new or existing IE. An IE may be a field of DCI. The existing IE may be reused by setting the field to all ones or zeros. For instance, an existing IE of existing DCI may be set to all ones or all zeros, which indicates that this existing DCI is re-used for indicating cell DTX/DRX skipping according to the present disclosure. Optionally, a first existing/new IE may be used to indicate that the configured cell DTX is to be skipped, and a second existing/new IE may be used to indicate that the configured cell DRX is to be skipped.

Optionally, the DCI used to carry the control information 102 may be UE-specific, group-common, or cell-specific DCI. The UE-specific DCI only applies to a specific UE. The group-common DCI applies to a group of UEs. The cell-specific DCI applies to the whole cell. In this way, one-to-one communication, multicast, and broadcast traffic can be respectively handled, and communications efficiency can be improved.

Optionally, when carrier aggregation is used, the cell is one of a plurality of serving cells, the control information may further indicate that the cell DTX/DRX shall be skipped in one or more other serving cells. For instance, the cell may be a primary cell, and the one or more other serving cells may be one or more secondary cells. In NR dual connectivity (DC) mode, the control information may be sent by the network device in a Primary Secondary cell (PSCell).

The network device 110 and the user device 120 are configured to skip the configured cell DTX/DRX during the time window and are configured to perform data transmission (or retransmission) during the time window, without deactivating or modifying the configured cell DTX/DRX. Before and after the time window, the network device 110 and the user device 120 are configured to follow the configured cell DTX/DRX.

In this way, there is no need to deactivate the cell DTX/DRX first to allow urgent data transmission and then activate the cell DTX/DRX again after urgent data transmission is finished. Signaling overhead can be reduced. Moreover, in comparison to modifying the cell DTX/DRX configurations (e.g., parameters such as “on duration” and/or “periodicity”), the present disclosure is more flexible, since urgent data may arrive in bursts, the modified cell DTX/DRX may not be suitable anymore for future traffic, and the energy saving effect may be affected by modifying the cell DTX/DRX. Therefore, the present disclosure is more flexible without substantially impacting the energy-saving effect of the configured cell DTX/DRX.

Optionally, before sending the control information 102, the user device 120 may send a request 101 to the network device 110, e.g., when the user device 120 determines that there is urgent (uplink) data to be transmitted to the network. The request 101 may comprise one-bit indication (or flag) indicating that the cell DTX/DRX skipping is requested. In this case, the network device 110 is configured to decide the time window for skipping the cell DTX/DRX. Alternatively, the request 101 may comprise a time window proposed by the user device 120. When the network device 110 determines that the time window proposed by the user device 120 is inappropriate, the network device 110 may indicate an overriding time window by using the control information 102 to the user device 120. When the network device 110 approves that the time window proposed by the user device, 120, the network device 110 may or may not confirm the approved time window.

FIG. 2 shows a further example of a network device 210 and a user device 220 according to the present disclosure. In FIG. 2, the user device 220 is configured to send a request 201 for skipping the configured cell DTX/DRX to the network device 210. Then, the user device 220 is configured to skip the configured DTX and/or DRX during a time window with or without a confirmation of the request from the network device 220.

Optionally, the request 201 may comprise a one-bit indication (or flag), or indicate a desired time window to be skipped with an optional shift value. The request may be sent by the user device 220 through UCI or a MAC CE.

The user device 220 may assume the request 201 is effective immediately and start monitoring DCI for possible uplink and/or downlink data transmission scheduling from the network device 210. Optionally, the network device 210 may be configured not to send any confirmation if the network device 210 agrees with the desired time window proposed by the user device 210. Alternatively, the network device 210 may explicitly confirm the request 201, or send a control information 202 to the user device 220 (when the request 201 only comprises one-bit indication, or the desired time window is not approved). The request 201 indicating the time window and/or the control information 202 indicating the time window may share the same features as the control information 102 disclosed in FIG. 1.

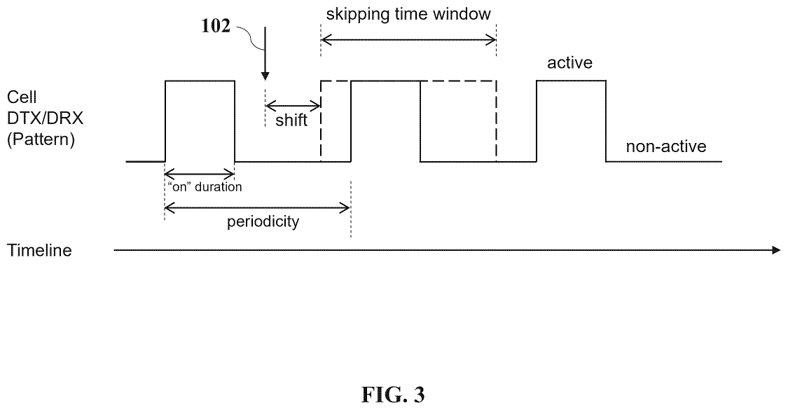

FIG. 3 shows an example of cell DTX/DRX skipping according to the present disclosure. Based on the disclosure of FIG. 1 and FIG. 2, as depicted in FIG. 3, cell DTX/DRX may be related to a plurality of periodic cycles. In each cycle, there is an active period and a non-active period. Each active period and each non-active period may comprise a plurality of time slots. A time slot may be seen as a basic scheduling unit for data transmission and may comprise a number of data symbols (e.g., OFDM symbols). Cell DTX/DRX may be configured (activated/deactivated) by, e.g., RRC configuration and may be defined by parameters such as periodicity, on duration, and start slot/offset. The control information 102 may indicate a duration value and an optional shift value. The duration value indicates a length of the time window, and the optional shift value indicates an optional delay for starting the time window.

When the control information 102 is sent/received during a non-active period, e.g., a time point T1, the time window may start from (T1+shift value) and end on (T1+shift value+duration value). That is, the time window=[T1+shift value, T1+shift value+duration value]. The shift value may be optional and may be any value larger than or equal to zero. When there is no shift value indicated by the control information 102, the shift value may be considered as equal to zero. In this case, the time window may start immediately (e.g., possibly in a same time slot) after sending/receiving the control information. Alternatively, when there is no shift value indicated by the control information 102, the shift value may be considered as equal to a default value, such as four time slots. The default value may be pre-defined and is known to the network device 110 and the user device 120.

Optionally, the shift value may be determined based on an estimated average processing time needed by the user device to decode relevant DCI.

Before and after the time window, the configured cell DTX/DRX still applies. That is, the configured cell DTX/DRX is not deactivated or modified.

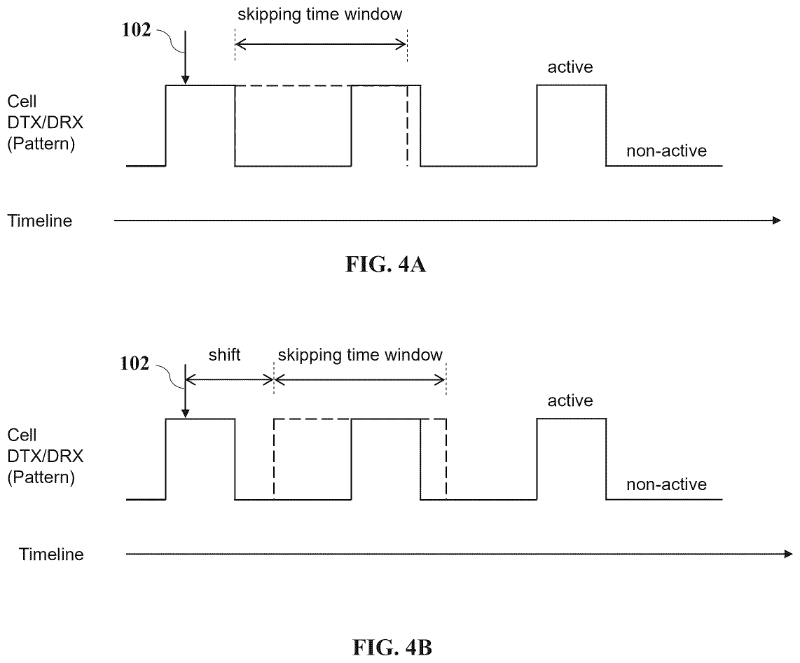

FIGS. 4A and 4B show further examples of cell DTX/DRX skipping according to the present disclosure. Based on the disclosure of FIG. 1-3, the control information 102 may be sent/received during an active period. As depicted in FIG. 4A, when the control information 102 does not indicate a shift value, the shift value may be considered as equal to zero or any other default value. Then, the time window may start on a first time slot of a non-active period subsequent to the active period. Alternatively, when the control information 102 does not explicitly indicate a shift value, a default shift value may apply. The default shift value may be pre-defined in a technical specification and is known to the network device and the user device.

In general, as depicted in FIG. 4B, when the control information 102 is sent/received during an active period and the control information 102 may indicate a shift value (including the default shift value not explicitly indicated), the actual delay may be MAX (the shift value, time to the subsequent inactive period). MAX ( ) denotes a max operation. Alternatively, the actual delay may be directly equal to the shift value, since even when the shift value is smaller than the time to the subsequent inactive period, the time window starts during the active period. This does not affect urgent data transmission. Since data transmission is nevertheless allowed during the active period.

Similar to FIG. 3, before and after the time window, the configured cell DTX/DRX still applies. That is, the configured cell DTX/DRX is not deactivated or modified.

FIG. 5 shows a diagram of a method 500 according to the present disclosure. The method 500 is performed by a network device associated with a cell configured with cell DTX/DRX.

The method 500 comprises the following steps:
step 501: sending, by the network device, control information to a user device, in which the control information indicates a time window, and the control information is used to notify the user device that the configured cell DTX/DRX is to be skipped during the time window; and
step 502: skipping, by the network device, the configured cell DTX/DRX during the time window for the user device.

The steps of the method 500 may share the same functions and details from the perspective of the network device shown in the FIGS. 1-4 described above. Therefore, the corresponding method implementations are not described again at this point.

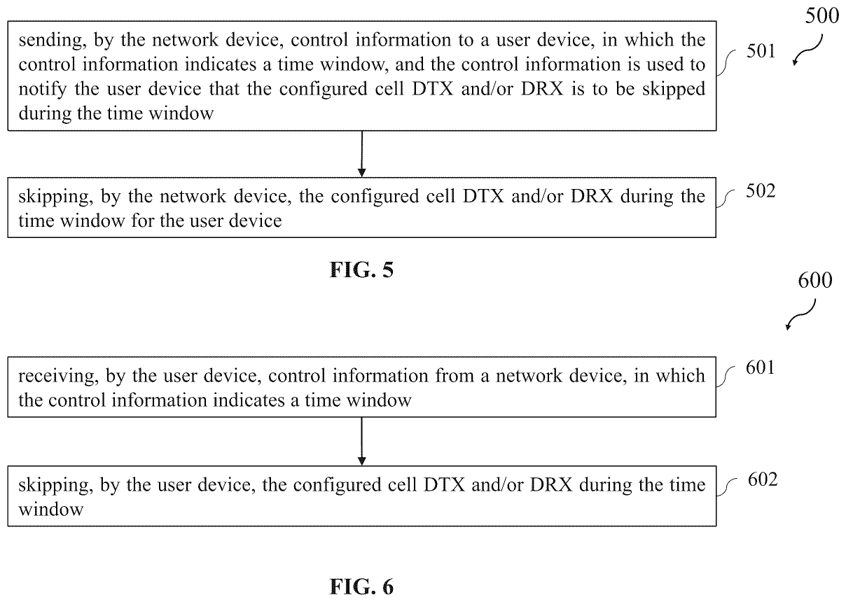

FIG. 6 shows a diagram of a further method 600 according to the present disclosure. The method 600 is performed by a user device associated with a cell configured with cell DTX/DRX.

The method 600 comprises the following steps:
step 601: receiving, by the user device, control information from a network device, in which the control information indicates a time window; and
step 602: skipping, by the user device, the configured cell DTX/DRX during the time window.

The steps of the method 600 may share the same functions and details from the perspective of the user device shown in the FIGS. 1-4 described above. Therefore, the corresponding method implementations are not described again at this point.

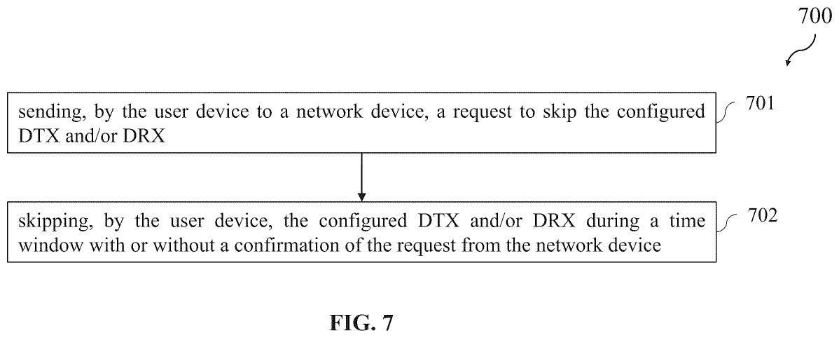

FIG. 7 shows a diagram of a further method 700 according to the present disclosure. The method 700 is performed by a user device associated with a cell configured with cell DTX/DRX.

The method 700 comprises the following steps:
step 701: sending, by the user device to a network device, a request to skip the configured DTX and/or DRX; and
step 702: skipping, by the user device, the configured DTX and/or DRX during a time window with or without a confirmation of the request from the network device.

The steps of the method 700 may share the same functions and details from the perspective of the user device shown in the FIGS. 1-4 described above. Therefore, the corresponding method implementations are not described again at this point.

In summary, the present disclosure proposes a skipping time window during which the configured cell DTX/DRX is temporarily skipped. This allows urgent data to be transmitted/received during the skipping time window without deactivating or modifying the configured cell DTX/DRX. For instance, traffic that is small in size and arrives randomly in bursts can be well handled according to the present disclosure with cell DTX/DRX configured. In this way, more flexibility can be introduced in cell DTX/DRX mechanism, and traffic QoS can be assured.

The present disclosure may be applied to any telecommunications networks/systems, such as but not limited to 5G (or NR), 6G mobile networks and the like. The network device and the user device in this disclosure each may comprise processing circuitry or a chipset (not shown) configured to respectively perform, conduct or initiate the various operations described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. Optionally, the processing circuitry (or the chipset) comprises one or more processors and a non-transitory memory connected to the one or more processors. The non-transitory memory may carry executable program code which, when executed by the one or more processors, causes the devices to perform, conduct or initiate the operations or methods described herein.

The present disclosure has been described in conjunction with various embodiments as examples as well as implementations. However, other variations can be understood and effected by those persons skilled in the art and practicing the claimed subject matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A method performed by a user device, wherein a cell associated with the user device is configured with cell discontinuous transmission (DTX), and/or discontinuous reception (DRX), and the method comprises:
receiving, by the user device, control information from a network device, wherein the control information indicates a time window; and
skipping, by the user device, the configured cell DTX and/or DRX during the time window.

2. The method according to claim 1, wherein the configured cell DTX and/or DRX relate to a plurality of cycles, wherein each cycle comprises an active time during which the cell is active and an inactive time during which the cell is inactive for transmitting and/or receiving one or more of a signal and a channel, and wherein:
based on the control information being sent during an active period, the time window starts from the first time slot of an inactive period subsequent to the active period.

3. The method according to claim 1, wherein for indicating the time window, the control information comprises a duration value denoting a length of the skipping window.

4. The method according to claim 3, wherein for indicating the time window, the control information further comprises a shift value denoting an amount of delay for starting the skipping window after receiving the control information.

5. The method according to claim 1, wherein for indicating the time window, the control information comprises an identity of a pre-defined time window, wherein the pre-defined time window is defined by a duration value and an optional shift value.

6. The method according to claim 1, wherein the control information further indicates that the time window applies to the configured cell DTX only, to the configured cell DRX only, or to both of the configured cell DTX and DRX.

7. The method according to claim 1, wherein the cell is one of a plurality of serving cells for carrier aggregation, and the control information further indicates that the time window applies to one or more other serving cells.

8. The method according to claim 1, wherein the control information is sent by the network device through downlink control information (DCI), wherein the DCI is associated with a specific type of radio network temporary identifier (RNTI), or the control information is sent by the network device through an information element (IE) of DCI.

9. The method according to claim 1, wherein before receiving the control information from the network device, the method further comprises:
sending, by the user device to the network device, a request to skip the configured cell DTX and/or DRX.

10. A method performed by a user device, wherein a cell associated with the user device is configured with cell discontinuous transmission (DTX), and/or discontinuous reception (DRX), and the method comprises:
sending, by the user device to a network device, a request to skip the configured DTX and/or DRX;
skipping, by the user device, the configured DTX and/or DRX during a time window with or without a confirmation of the request from the network device.

11. The method according to claim 10, wherein the request comprises a one-bit flag, or indicates a desired time window to be skipped with an optional shift value, and wherein the request is sent by the user device through uplink control information (UCI), or a medium access control (MAC) control element (CE).

12. A user device, wherein the user device is associated with a cell configured with cell discontinuous transmission (DTX), and/or discontinuous reception (DRX), and the user device comprises:
a processor; and
a memory coupled to the processor and having processor-executable instructions stored thereon, which upon being executed by the processor facilitate the user device to:
receive control information from a network device, wherein the control information indicates a time window; and
skip the configured cell DTX and/or DRX during the time window.

13. A system comprising a network device, and one or more user devices according to claim 12.

14. A computer program comprising instructions which, upon the program is executed by a computer, cause the computer to perform the method according to claim 1.

15. The method according to claim 2, wherein based on the control information being sent during the active period, the time window starts from the first time slot of the inactive period subsequent to the active period with delay.

16. The method according to claim 1, wherein the configured cell DTX and/or DRX relate to a plurality of cycles, wherein each cycle comprises an active time during which the cell is active and an inactive time during which the cell is inactive for transmitting and/or receiving one or more of a signal and a channel, and wherein:
based on the control information being sent on a specific time slot during an inactive period, the time window starts from the specific time slot.

17. The method according to claim 16, wherein based on the control information being sent on the specific time slot during the inactive period, the time window starts from the specific time slot with delay.

18. The user device according to claim 12, wherein for indicating the time window, the control information comprises a duration value denoting a length of the skipping window.

19. The user device according to claim 18, wherein for indicating the time window, the control information further comprises a shift value denoting an amount of delay for starting the skipping window after receiving the control information.

20. The user device according to claim 12, wherein for indicating the time window, the control information comprises an identity of a pre-defined time window, wherein the pre-defined time window is defined by a duration value and an optional shift value.
